(19) United States
(12) Patent Application Publication
(10) Pub. No.: US 2010/0102745 A1
(43) Pub. Date: Apr. 29, 2010

(54) 190W POWER LIMITER CIRCUIT FOR LIGHTING EQUIPMENT

(76) Inventor: HSI-CHOU WU, TAINAN COUNTY (TW)

Correspondence Address: J C PATENTS, 4 VENTURE, SUITE 250, IRVINE, CA, 92618, US

(21) Appl. No.: 12/258,993

(22) Filed: Oct. 27, 2008

(51) Int. Cl. H05B 41/36

(52) U.S. Cl. 315/291

(57) ABSTRACT

A 190 W power limiter circuit for lighting equipment includes a DC power supply unit employed to transform an AC power source into a low DC output voltage, a DC voltage regulator used to regulate the DC power supply unit for a micro controller unit, an AC synchronization unit utilized to receive a synchronization signal of an AC line frequency and an AC voltage variation that are sent to the micro controller unit to achieve a synchronous triggering with the AC line frequency for driving an AC lamp driver unit, and an AC current sensor unit used to induct AC of a load circuit and having a resistor, manganese copper, a semi-conductor IC or a current transformer, which is connected to AC lamps in series, able to create voltage inducting signals fed back to the micro controller unit to adjust a triggering angle of the AC lamp driver unit for keeping power consumption less than 190W despite the load change of the lamps.

### BACKGROUND OF THE INVENTION

1. Field of the Invention

This invention relates to a 190 W power limiter circuit for lighting equipment, particularly to one installed with a DC current sensor unit provided with a resistor, manganese copper, a semi-conductor IC or a current transformer, which are connected to AC lamps in series, able to create voltage inducting signals corresponding to alternative current of a load circuit. The inducting signals are then fed back to the micro controller unit that is to consecutively analyze the AC synchronization signal and the AC voltage variation signal to output an adjusted signal for being synchronous with the AC line frequency to adjust a triggering angle of the AC lamp driver unit. Thus, power consumption of lamps can be kept less than 190 W no matter how the load of lamps is enlarged or how the AC voltage or the alternative current of the load is changed.

2. Description of the Prior Art

Commonly, conventional house lamps or those fixed on a ceiling are directly connected with an AC power source, or connected with the ceiling fan. However, when extra lamps are installed by a user, a regulation restricting a load less than 190 W may be violated as the user cannot realize whether power consumption of the load surpasses 190 W or not.

### SUMMARY OF THE INVENTION

The object of this invention is to offer a 190 W power limiter circuit for lighting equipment. That is, power consumption of the lamps can be always restricted within 190 W either the lamps are replaced with those having a higher power or the AC voltage or the alternative current of the load are changed.

The main characteristics of the invention are a DC power supply unit, a DC voltage regulator unit, an AC synchronization unit, a micro controller unit, an AC lamp driver unit and an AC current sensor unit.

The DC power supply unit is directly connected with an AC power source, employed to transform a high voltage of the AC power source into a low DC output voltage so as to supply power for successive units.

The DC voltage regulator unit is connected to the DC power supply unit, used to regulate voltage of a current outputted from the DC power supply unit to a micro controller unit.

The AC synchronization unit is utilized to receive an AC synchronization signal of an AC line frequency, an AC voltage variation signal and a voltage inducting signal corresponding to alternative current of the load circuit, and the signals are consecutively sent to the micro controller unit that is to achieve a synchronous triggering with the AC line frequency so as to drive the AC lamp driver unit.

The AC current sensor unit is used to induct alternative current of a load circuit, having its inducting device provided with a resistor, manganese copper, a semi-conductor IC or a current transformer, which is connected to AC lamps in series, able to create voltage inducting signals corresponding to alternative current of the load circuit. The inducting signals are then fed back to the micro controller unit that is to consecutively analyze the AC synchronization signal and the AC voltage variation to be synchronous with the AC line frequency to adjust the triggering angle of the AC lamp driver unit. Thus, power consumption of the lamps can be kept less than 190 W no matter how the load of lamps is enlarged or how the AC voltage or the alternative current of the load are changed.

The 190 W power limiter circuit for lighting equipment in the invention can be employed not only in independent general lighting equipment, but also in that combined together with a ceiling fan.

### BRIEF DESCRIPTION OF DRAWINGS

This invention is better understood by referring to the accompanying drawings, wherein:

FIG. 1 is a flowchart of a first preferred embodiment of a 190 W power limiter circuit for lighting equipment in the present invention;

FIG. 2 is a flowchart of a second preferred embodiment of a 190 W power limiter circuit for lighting equipment in the present invention;

FIG. 3 is a flowchart of a third preferred embodiment of a 190 W power limiter circuit for lighting equipment in the present invention; and

FIG. 4 is a flowchart of a fourth preferred embodiment of a 190 W power limiter circuit for lighting equipment in the present invention.

### DETAILED DESCRIPTION OF THE PREFERRED EMBODIMENT

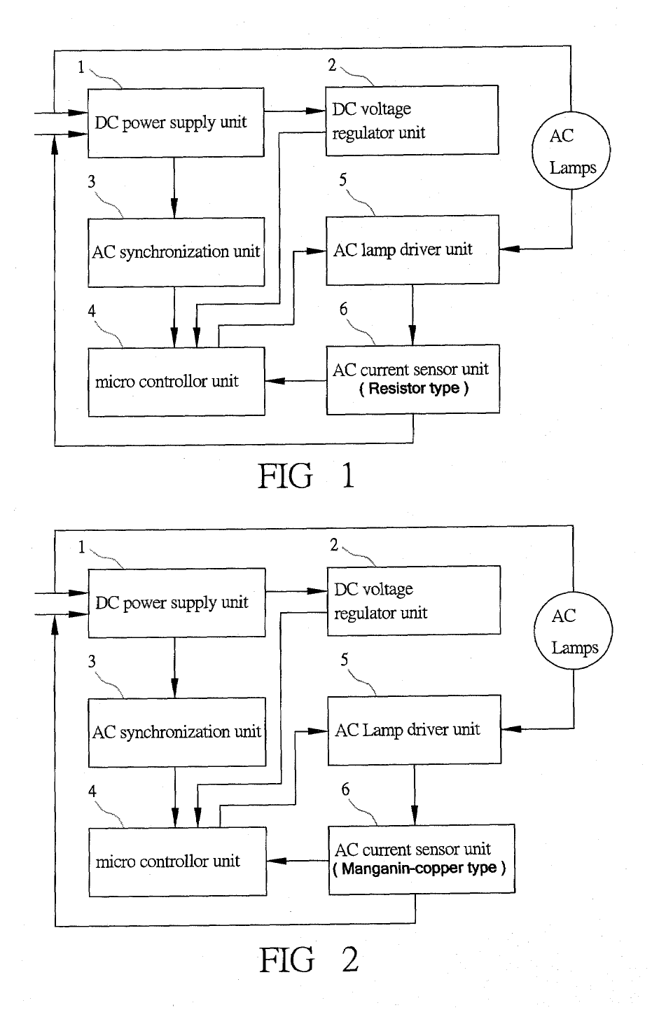

As shown in FIG. 1, a first preferred embodiment of a 190 W power limiter circuit for lighting equipment in the present invention includes a DC power supply unit 1, an DC voltage regulator unit 2, an AC synchronization unit 3, a micro controller unit 4, an AC lamp driver unit 5 and an AC current sensor unit 6.

The DC power supply unit 1 is directly connected with an AC power source, employed to transform the high voltage of the AC power source into a low DC output voltage so as to supply power for successive units.

The DC voltage regulator unit 2 is connected to the DC power supply unit 1, used to regulate the voltage of the current outputted from the DC power supply unit 1 to the micro controller unit 4.

The AC synchronization unit 3 is connected with the DC power supply unit 1, used to receive the AC synchronization signal and the AC voltage variation coming from the DC power supply unit 1, with the signals consecutively sent to the micro controller unit 4.

The micro controller unit 4 is utilized to receive the AC synchronization signal of the AC line frequency and the AC voltage variation coming from the AC synchronization unit 3 and then analyze them. With reference to the AC inducting signals of a load circuit and by means of the synchronous triggering of the AC line frequency, the micro controller unit 4 can thus drive the AC lamp driver unit 5 synchronously so that the AC lamps can be successively driven to work.

The AC lamp driver unit 5 is employed to receive triggering signals sent from the micro controller unit 4 so as to be synchronous with the AC line frequency to drive the AC lamps.

The AC current sensor unit 6 is used to induct the alternative current of a load circuit, having its inducting device provided with a resistor connected to the AC lamps in series. The resistor is able to create voltage inducting signals corresponding to the alternative current of the load circuit and the inducting signals are then fed back to the micro controller unit 4, which is to consecutively analyze the AC synchronization signal and the AC voltage variation to be synchronous with the AC line frequency to adjust the triggering angle of the AC lamp driver unit 5, so as to keep the AC lamps having a load within 190 W.

As shown in FIG. 2, a second preferred embodiment of a 190 W power limiter circuit for lighting equipment in the present invention has the same components as the first embodiment does, except that the AC current sensor unit 6 is provided with a manganese copper connected to the AC lamps in series. The manganese copper is as well able to create voltage inducting signals corresponding to the alternative current of the load circuit and the inducting signals are then fed back to the micro controller unit 4, which is to consecutively analyze the AC synchronization signal and the AC voltage variation to be synchronous with the AC line frequency to adjust the triggering angle of the AC lamp driver unit 5, so as to keep the AC lamps having a load within 190 W.

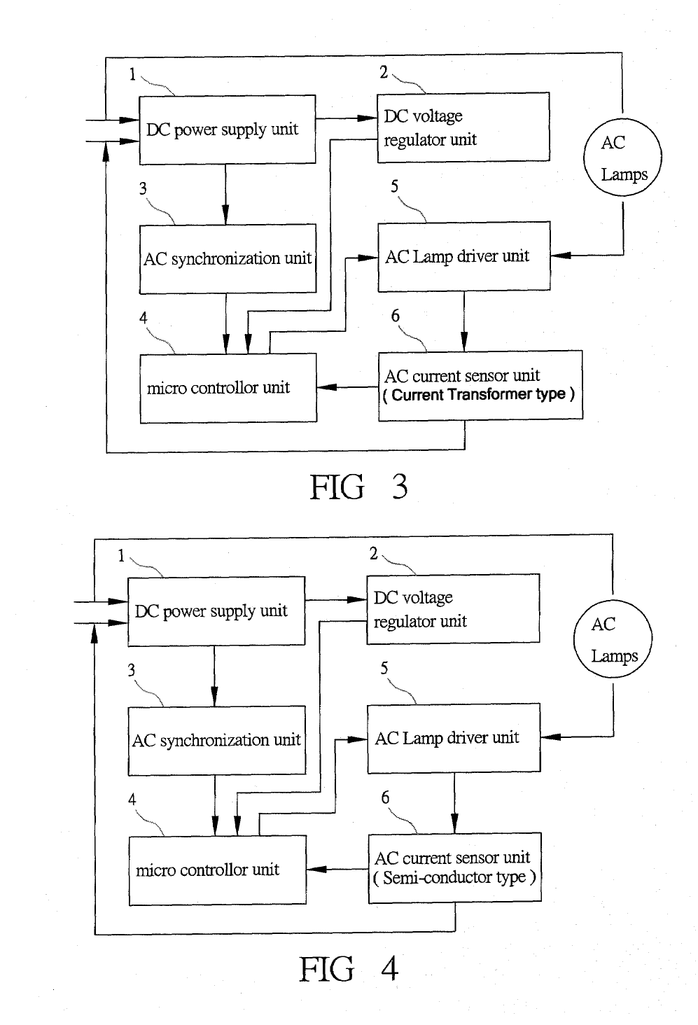

As shown in FIG. 3, a third preferred embodiment of a 190 W power limiter circuit for lighting equipment in the present invention has the same components as the first embodiment does, except that the AC current sensor unit 6 is provided with a current transformer connected to the AC lamps in series. The secondary coil of the current transformer is as well able to create voltage inducting signals corresponding to the alternative current of the load circuit and the inducting signals are then fed back to the micro controller unit 4, which is to consecutively analyze the AC synchronization signal and the AC voltage variation to be synchronous with the AC line frequency to adjust the triggering angle of the AC lamp driver unit 5, so as to keep the AC lamps having a load within 190 W.

As shown in FIG. 4, a fourth preferred embodiment of a 190 W power limiter circuit for lighting equipment in the present invention has the same components as the first embodiment does, except that the AC current sensor unit 6 is provided with a semi-conductor IC connected to the AC lamps in series. The output of the semi-conductor IC is as well able to create voltage inducting signals corresponding to the alternative current of the load circuit and the inducting signals are then fed back to the micro controller unit 4, which is to consecutively analyze the AC synchronization signal and the AC voltage variation to be synchronous with the AC line frequency to adjust the triggering angle of the AC lamp driver unit 5, so as to keep the AC lamps having a load within 190 W.

Obviously, with the AC current sensor unit 6 provided with the resistor, the manganese copper, a current transformer or a semi-conductor IC for being connected with AC lamps in series, a necessary voltage inducting signal corresponding to the alternative current can be obtained and fed back to the micro controller unit 4, which is to consecutively analyze the AC synchronization signal and the AC voltage variation to be synchronous with the AC line frequency to adjust the triggering angle of the AC lamp driver unit 5, so as to keep the AC lamps having a load within 190 W, lessening power consumption for saving energy.

While the preferred embodiment of the invention has been described above, it will be recognized and understood that various modifications may be made therein and the appended claims are intended to cover all such modifications that may fall within the spirit and scope of the invention.

What is claimed is:

1. A 190 W power limiter circuit for lighting equipment, said circuit comprising:
a DC power supply unit directly connected with an AC power source and employed to transform a high voltage of said AC power source into a low DC output voltage so as to supply power for successive units;
a DC voltage regulator unit connected to said DC power supply unit and used to regulate voltage of a current outputted from said DC power supply unit to a micro controller unit;
an AC synchronization unit utilized to receive an AC synchronization signal of an AC line frequency and an AC voltage variation, said AC synchronization signal and said AC voltage variation consecutively sent to a micro controller unit 4;
said micro controller unit employed to process said AC synchronization signal and said AC voltage variation and an AC voltage signal corresponding to alternative current of a load circuit so as to achieve a synchronous triggering with said AC line frequency for driving an AC lamp driver unit; and
an AC current sensor unit used to induct alternative current of a load circuit and provided with an inducting device such as a resistor or manganese copper or a semi-conductor IC or a current transformer, said inducting device connected to AC lamps in series and able to create voltage inducting signals corresponding to alternative current of said load circuit, said inducting signals then fed back to said micro controller unit that is to consecutively analyze said AC synchronization signal and said AC voltage variation to be synchronous with said AC line frequency to adjust a triggering angle of said AC lamp driver unit so as to keep power consumption less than 190 W no matter how a load of lamps is enlarged or how an AC voltage or an alternative current of said load are changed.
